(19) United States
(12) Patent Application Publication
(10) Pub. No.: US 2007/0107560 A1
(43) Pub. Date: May 17, 2007

(54) Ratchet wrench

(75) Inventor: Wan-Feng Chiang, Taichung Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: DING SHUN IND. CO., LTD., Taiping City (TW)

(21) Appl. No.: 11/274,961

(22) Filed: Nov. 16, 2005

(51) Int. Cl. B25B 13/46

(52) U.S. Cl. 81/63.2; 81/60

(57) ABSTRACT

The ratchet wrench has a body, a drive ring, two pawls, two resilient arms, a retaining ring and a split ring. The body has a handle and a box end with a ratchet hole and multiple ratchet teeth formed around and protruding into the ratchet hole. The drive ring and pawls are mounted rotatably in the ratchet hole, and the resilient arms connect the pawls to the drive ring and press the pawls against the ratchet teeth. The retaining ring is mounted around the drive ring and holds the retaining ring in the ratchet hole. The split ring connects the retaining ring to the drive ring.

### BACKGROUND OF THE INVENTION

1. Field of the Invention

The present invention relates to a ratchet wrench, and more particularly to a box end ratchet wrench that can be assembled quickly.

2. Description of Related Art

Many types of wrenches exist and include adjustable wrenches, box end wrenches, open-end wrenches and ratchet wrenches. Conventional ratchet wrenches have many different forms.

With reference to FIG. 6, a typical conventional ratchet wrench (80) has a body (81), a drive ring (88), a pawl (85), a spring-ball combination (86) and a selector (87).

The body (81) comprises a box end (not numbered) and a handle (not numbered). The box end is mounted selectively on a nut (not shown) or bolt (not shown) and has a through hole (82). The through hole (82) has an inside surface (not numbered) and a pawl recess (not numbered). The pawl recess is formed in the inside surface.

The drive ring (88) is mounted rotatably in the through hole (82) of the body (81) and has an external surface (not numbered), an internal surface (not numbered), multiple ratchet teeth (84) and multiple points (83). The ratchet teeth (84) are formed on and protrude out from the external surface. The points (83) hold a nut or a bolt and are formed on and protrude in from the internal surface.

The pawl (85) is mounted moveably in the pawl recess, engages the ratchet teeth (84), turns the drive ring (88) when the handle is turned in one direction and has two ends (not numbered), an inside edge (not numbered), an outside edge (not numbered) and multiple pawl teeth (851).

The pawl teeth (851) are formed on and protrude in from the inside edge, selectively engage the ratchet teeth (84) and turn the drive ring (88) in one direction. The pawl teeth (851) on one end of the pawl (85) cause the drive ring (88) to turn in one direction when the pawl teeth (851) engage the ratchet teeth (84), and the pawl teeth (851) on the opposite end cause the drive ring (88) to turn in the opposite direction when the pawl teeth (851) engage the ratchet teeth (84).

The spring-ball combination (86) is mounted in the pawl recess and presses the pawl (85) against the drive ring (88) so the desired pawl teeth (851) engage the ratchet teeth (84).

The selector (87) is mounted slidably through the pawl (85) and the pawl recess and presses the pawl teeth (851) against the ratchet teeth (84) on the drive ring (88) to control the direction in which the box end turns when the handle is pulled.

However, the conventional ratchet wrench (80) has the following shortcomings.

1. The pawl teeth (851) on only one end of the pawl (85) engage the ratchet teeth (84) on the drive ring (88). Consequently, all the force applied to a nut or a bolt to turn the nut or bolt is applied to just a few pawl teeth (851) and ratchet teeth (84), which limits the force that can be applied to the wrench and causes the pawl teeth (851) and ratchet teeth (84) to wear down quickly.

2. The ratchet device has many elements, which causes the structure of the ratchet wrench (80) to be complicated. Consequently, the cost to manufacture the conventional ratchet wrench (80) will be high. The spring (86) and the pawl (85) increase the volume and mobility of the ratchet wrench (80).

3. The single pawl (85) to engage the ratchet teeth (84) causes an asymmetrical force to be applied to the drive ring (88), which effects the strength of the ratchet wrench (80) and the ability to turn a nut or bolt.

### SUMMARY OF THE INVENTION

The main objective of the present invention is to provide a ratchet wrench with a high twisting strength.

The ratchet wrench in accordance with the present invention has a body, a drive ring, two pawls, two resilient arms, a retaining ring and a split ring. The body has a handle and a box end with a ratchet hole and multiple ratchet teeth formed around and protruding into the ratchet hole. The drive ring and pawls are mounted rotatably in the ratchet hole, and the resilient arms connect the pawls to the drive ring and press the pawls against the ratchet teeth. The retaining ring is mounted around the drive ring and holds the retaining ring in the ratchet hole. The split ring connects the retaining ring to the drive ring.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a ratchet wrench in accordance with the present invention;

FIG. 2 is an exploded perspective view of the ratchet wrench in FIG. 1;

FIG. 3 is a side view in partial section of the ratchet wrench in FIG. 1;

FIG. 4 is an operational top view of the ratchet wrench in FIG. 1 turning a nut or bolt in a clockwise direction with the connecting ring removed to show the internal arrangement of the box end;

FIG. 5 is a top view of the ratchet wrench in FIG. 1 turning in a counterclockwise direction without turning the nut or bolt with the connecting ring removed to show the internal arrangement of the box end;

FIG. 6 is a top view in partial section of a conventional ratchet wrench in accordance with the prior art.

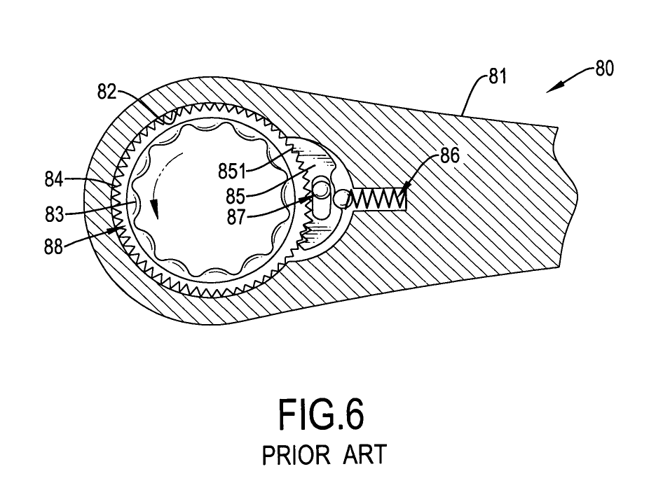

### DETAILED DESCRIPTION OF THE PREFERRED EMBODIMENT

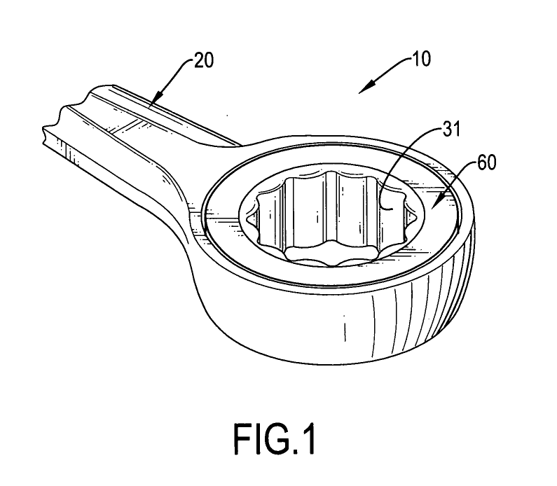

With reference to FIGS. 1, 2 and 3, a ratchet wrench (10) in accordance with the present invention comprises a body (20), a drive ring (30), two pawls (40), two resilient arms (50), a retaining ring (60) and a split ring (70).

The body (20) comprises a box end and a handle. The box end is mounted selectively on a nut (not shown) or a bolt (not shown) and has a top, a bottom, a ratchet hole (21) and an inside edge. The ratchet hole (21) is formed through the box end from the top to the bottom and has a diameter. The inside edge is formed around the ratchet hole (21) and has multiple ratchet teeth (22) protruding into the ratchet hole (21).

The drive ring (30) is mounted rotatably in the ratchet hole (21) and has a center, a top, a bottom, a drive hole (31), an external surface, two pawl recesses (32), two mounting holes (35) and an outer annular groove (36).

The bottom slidably abuts the bottom of the box end to hold the drive ring (30) in the ratchet hole (21) and has a diameter and multiple optional protrusions. The diameter of the bottom may be larger than the diameter of the ratchet hole (21). Alternately, protrusions may extend radially out from the bottom of the drive ring (30) and slidably abut the bottom of the box end around the ratchet hole (21) when the drive ring (30) is mounted in the ratchet hole (21).

The drive hole (31) is formed through the center of the drive ring (30) and has an internal drive surface that may be multiple points or multiple flat surfaces.

The external surface is formed around the drive ring (30) and comprises two flat surfaces (33) and two curved surfaces (34). The two flat surfaces (33) are formed opposite to each other. The two curved surfaces (34) separate the flat surfaces (33).

The pawl recesses (32) are formed opposite to each other in the external surface and correspond respectively to the flat surfaces (33).

The mounting holes (35) are defined in the top of the drive ring (30) opposite to each other and correspond respectively to the curved surfaces (34) of the external surface.

The outer annular groove (36) is formed in the drive ring (30) near the top.

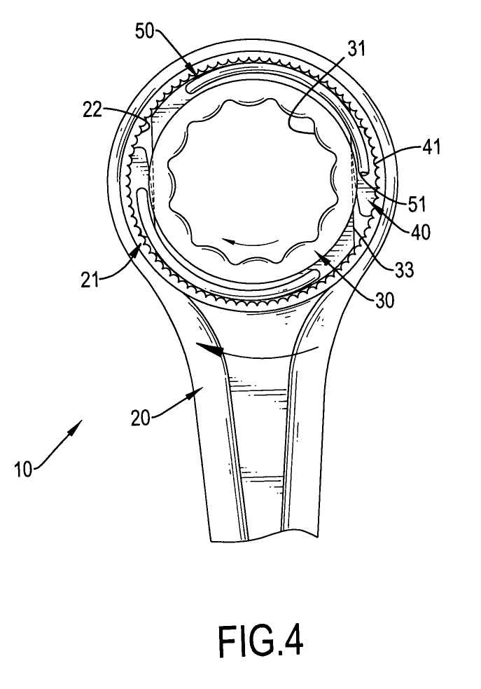

The pawls (40) are mounted moveably respectively in the pawl recesses (32) respectively against the flat surfaces (33), and each pawl (40) has a flat inner surface, a curved outer surface, a top, multiple pawl teeth (41) and an arm hole (42). The flat inner surface slidably abuts the corresponding flat surface (33) of the exterior surface of the drive ring (30). With further reference to FIG. 4, the pawl teeth (41) are formed on and protrude out from the curved outer surface and selectively engage the ratchet teeth (22) when the body (20) is turned in one direction.

The arm hole (42) is formed in the top of the pawl (40).

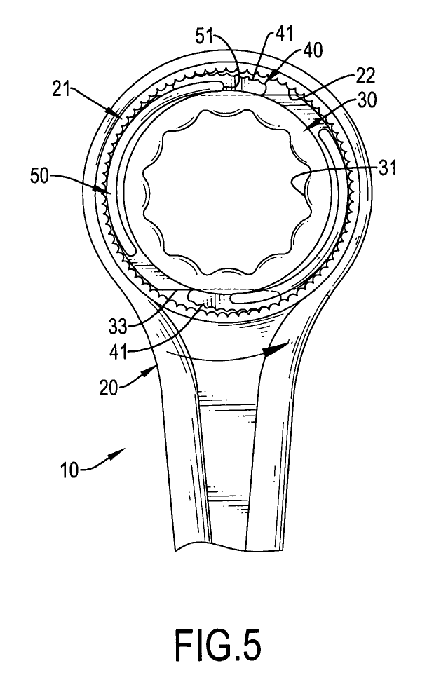

The resilient arms (50) are mounted between the drive ring (30) and the pawls (40) and press the pawls (40) against the ratchet teeth (22) when the body (20) is turned in one direction. Each resilient arm (50) has a stationary end, a moveable end and two prongs (51). The prongs (51) are formed respectively at and perpendicular to the stationary and moveable ends of the resilient arm (50) and are mounted respectively in the corresponding mounting hole (35) and the corresponding arm hole (42). When the body (20) is rotated in one direction, the resilient arms (50) cause all of the pawl teeth (41) to engage corresponding ratchet teeth (22). With further reference to FIG. 5, the resilient arms (50) pull some of the pawl teeth (41) on each pawl (40) away from the ratchet teeth (22) and allow the pawls (40) and the drive ring (30) to slide an not turn when the body (20) is turned in the opposite direction.

The retaining ring (60) is mounted around the top of and holds the drive ring (30) rotatably in the ratchet hole (21) and has an internal surface, a bottom surface and an inner annular groove (61). The bottom surface slidably abuts the top of the body (20) around the ratchet hole (21). The inner annular groove (61) is formed in the internal surface of the retaining ring (60) and corresponds to and aligns with the outer annular groove (36) in the drive ring (30).

The split ring (70) is resilient, is mounted around the drive ring (30) in the outer annular groove (36) and in the inner annular groove (61) in the retaining ring (60) and has a gap (71). The gap (71) is formed in the split ring (70) to allow the split ring (70) to be easily mounted in the connecting ring (60).

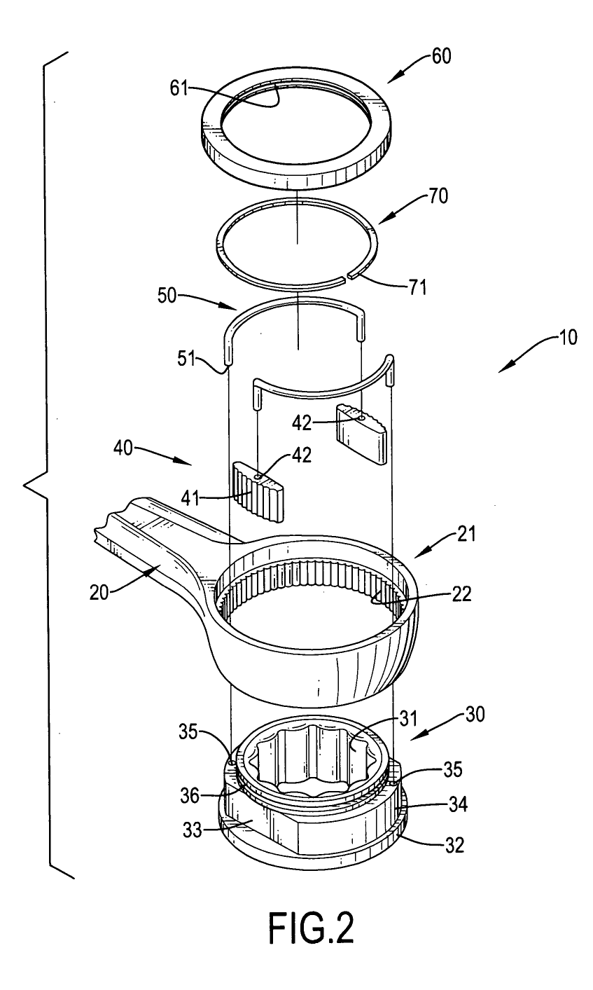

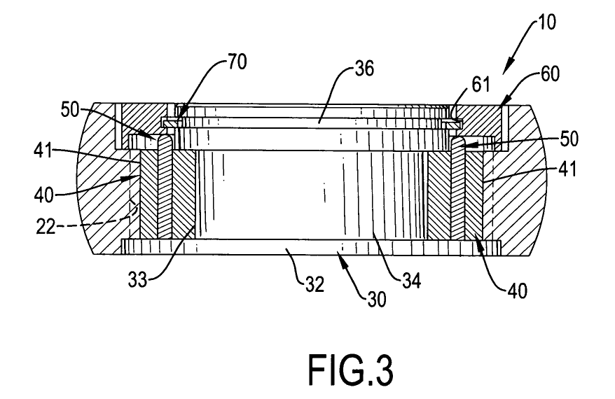

With reference to FIGS. 2 and 3, to assemble the ratchet wrench (10), the driver ring (30) is mounted into the ratchet hole (21) of the body (20) from the bottom of the body (20), and each pawl (40) is mounted between the ratchet teeth (22) of the ratchet hole (21) and the corresponding pawl recess (33). Then, one of the prongs (51) of each resilient arm (50) is inserted into one of the mounting holes (35) in the drive ring (30), and the other prong (51) is inserted into the arm hole (42) of one of the pawls (40). Finally, the split ring (70) is mounted between the outer annular groove (36) and the inner annular groove (61) to achieve the ratchet wrench (10) as shown in FIG. 1.

In use, with reference to FIG. 4, the pawl teeth (41) of each pawl (40) engage with the ratchet teeth (22) of the ratchet hole (21) by the action of the resilient arms (50).

When the body (20) is turned in an appropriate direction, such as the clockwise direction as shown in the FIG. 4, the pawl (40) will fully engage with the ratchet teeth (22) on the ratchet hole (21) with the force provided by the resilient arms (50). Accordingly, the ratchet wrench (10) can provide a greater twist strength than a conventional one to avoid wear and tear of the teeth (22,41).

With reference to FIG. 5, When the body (20) moves along the opposite direction, such as the counterclockwise direction as shown in the FIG. 5, each pawl (40) will be pushed away to disengage from the ratchet teeth (22) on ratchet hole (21) to keep the drive ring (30) from rotating with the body (20). Consequently, user can turn back and forth to operate the ratchet wrench (10) without setting a spring-ball combination (86) as the conventional one.

The ratchet wrench (10) as described has the following advantages.

1. When the body (20) is turned to turn a nut or bolt, the resilient arms (50) push all the pawl teeth (41) against corresponding ratchet teeth (22) in the ratchet hole (21) so the force applied to individual teeth is reduced. Therefore, a greater force can be applied to the ratchet wrench (10) without damaging or wearing the teeth (22,41).

2. Omission of a selector (87) simplifies the design of the ratchet wrench (10). Changing the direction a nut or bolt is turned is accomplished by simply turning the wrench (10) over. Therefore, the cost to manufacture the ratchet wrench (10) effectively reduced. In addition, designing the pawls (40) to mount on the drive ring (30) significantly reduces the volume of the box end of the body (20) and increases the flexibility of the ratchet wrench (10).

3. With the pawls (40) mounted opposite to each other on the drive ring (30), the force applied to the drive ring (30) is balanced so a larger force can be applied to the ratchet wrench (10) without applying undue transverse forces to the drive ring (30).

4. Eliminating threaded components between the retaining ring (60) and the drive ring (30) further simplifies the design of the ratchet wrench (10) by using the split ring (70) to hold the drive ring (30) in the ratchet hole (21). Thus, the cost and time to assemble the ratchet wrench (10) are significantly reduced.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A ratchet wrench comprising
a body comprising
a box end having
a top;
a bottom;
a ratchet hole formed through the box end from the top to the bottom and having a diameter; and
an inside edge formed around the ratchet hole and having multiple ratchet teeth protruding into the ratchet hole; and
a handle;
a drive ring mounted rotatably in the ratchet hole and having
a center;
a top;
a bottom slidably abutting the bottom of the box end to hold the drive ring in the ratchet hole and having a diameter;
a drive hole formed through the center of the drive ring and having an internal drive surface;
an external surface formed around the drive ring and comprising
two flat surfaces formed opposite to each other; and
two curved surfaces separating the flat surfaces;
two pawl recesses formed opposite to each other in the external surface and corresponding respectively to the flat surfaces;
two mounting holes defined in the top of the drive ring opposite to each other and corresponding respectively to the curved surfaces of the external surface; and
an outer annular groove formed in the drive ring near the top;
two pawls mounted moveably respectively in the pawl recesses respectively against the flat surfaces and each pawl having
a flat inner surface slidably abutting the corresponding flat surface of the exterior surface of the drive ring;
a curved outer surface;
a top;
multiple teeth formed on and protruding out from the curved outer surface and selectively engaging the ratchet teeth when the body is turned in one direction; and
an arm hole formed in the top of the pawl;
two resilient arms mounted between the drive ring and the pawls and pressing the pawls against the ratchet teeth when the body is turned in one direction, and each resilient arm having
a stationary end;
a moveable end; and
two prongs formed respectively at and perpendicular to the stationary and moveable ends of the resilient arm and mounted respectively in one of the mounting holes in the driving ring and the arm hole of one of the pawl;
the retaining ring mounted around the top of and holding the drive ring rotatably in the ratchet hole and having
an internal surface;
a bottom surface slidably abutting the top of the body around the ratchet hole; and
an inner annular groove formed in the internal surface of the retaining ring and corresponding to and aligning with the outer annular groove in the drive ring; and
the split ring being resilient, mounted around the drive ring in the outer annular groove and in the inner annular groove in the retaining ring and having a gap formed in the split ring.

2. The ratchet wrench as claimed in claim 1, wherein the internal drive surface of the drive hole has multiple points.

3. The ratchet wrench as claimed in claim 2, wherein the diameter of the bottom of the drive ring is larger than the diameter of the ratchet hole.

4. The ratchet wrench as claimed in claim 1, wherein the diameter of the bottom of the drive ring is larger than the diameter of the ratchet hole.
